(19) United States
(12) Patent Application Publication
(10) Pub. No.: US 2019/0074894 A1
(43) Pub. Date: Mar. 7, 2019

(54) CONVERGENT ARCHITECTURES FOR MULTI-ORBIT SATELLITE COMMUNICATIONS

(71) Applicant: Hughes Network Systems, LLC, Germantown, MD (US)

(72) Inventor: Rajeev GOPAL, North Potomac, MD (US)

(21) Appl. No.: 16/122,269

(22) Filed: Sep. 5, 2018

Related U.S. Application Data
(60) Provisional application No. 62/554,492, filed on Sep. 5, 2017.

(51) Int. Cl. H04B 7/185; H04W 16/14

(52) U.S. Cl. CPC H04B 7/18584; H04B 7/18519; H04W 16/14; H04B 7/18521; H04B 7/18513

(57) ABSTRACT

Convergent architectures across communications systems utilizing satellites in multiple orbits can provide better services by increasing efficiencies in network infrastructure build out and spectrum utilization. Convergence can be achieved in network, data link and physical layers. Network layer convergence facilitates the use of common building blocks based on industry standards. Data link layer convergence employs dynamic sharing of resources across heterogeneous platforms in different orbits, facilitated by an inter-system knowledge of estimated and actual traffic demand, radio environment and standalone resource availability including the part which may go unutilized. Besides time, frequency, and power dimensions, our convergence framework introduces dynamic awareness of platform location, trajectory, and traffic demands. A centralized and multi-tiered data-broker type resource availability orchestration provides a scalable approach for increased utilization of spectrum, traditionally assigned statically to specific orbits and applications.

### RELATED APPLICATIONS

This application claims the benefit of the earlier filing date under 35 U.S.C. § 119(e) from U.S. Provisional Application Ser. No. 62,554,492 (filed 2017-09-05), the entirety of which is incorporated by reference herein.

### BACKGROUND

Communication satellites in the Geo-Synchronous Orbits (GSO) today provide broadband services to underserved and unserved areas around the world. The High Throughput Satellite (HTS) technology, introduced in GSO, has been a major disruptive force for enhancing capacity, reducing costs, and enlarging the subscriber base. With the increasing proliferation of 4G terrestrial cellular deployments and imminent 5G improvements, both satellite and terrestrial technologies will continue to complement each other (e.g., satellite-based backhauls for cellular towers and IP-based interoperability) towards the end-goal of worldwide ubiquitous and universal connectivity.

With efficient Radio Frequency (RF) waveforms, scalable and configurable hardware and software implementations, and cost-effective operational capabilities, the primary barrier to any kind of radio communication is now clearly the scarcity of spectrum. This is leading to business, regulatory and technical innovations that can lead to better coordination and sharing amongst competitive technologies and platforms which can address both service provider's revenue and new services such as Internet-of-Things (IoT).

What is needed, therefore, is an approach for convergence across communications satellites (platforms) in various GSO and NGSO orbits, considering various facets including user network layer processing, spectral sharing, and costs within the context of broadband and IoT services.

### SOME EXAMPLE EMBODIMENTS

Embodiments of the present invention advantageously address the foregoing requirements and needs, as well as others, by providing an approach and network architecture for convergence across communications satellites (platforms) in various GSO and NGSO orbits, considering various facets including user network layer processing, spectral sharing, and costs within the context of broadband and IoT services.

End user network interface for wireless broadband infrastructure is now increasingly based on Wi-Fi (unlicensed spectrum) and 3G/4G LTE (licensed spectrum) standards. Both traditional wide beam and HTS GSO satellites provide Very Small Aperture Terminals (VSATs) for customer premises that enable IP-based services over Ethernet or Wi-Fi based interfaces for accessing the Internet similar to the 4G/LTE networks. Thus the user network interface has already been benefiting from IP-based convergent trends cutting across both satellite and terrestrial technologies. Beyond this interface, however, the various satellite and terrestrial transports have traditionally employed distinct and incompatible designs for RF communication using spectrum that is statically assigned by regulatory agencies which constraints the potential utilization of unused spectrum.

Recently, new architectures have pioneered the use of 4G/LTE designs for the next generation HTS systems especially with NGSO constellations. See Vasavada, Gopal, Ravishankar, BenAmmar, and Zakaria, “Architectures for next generation high throughput satellite systems,” http://onlinelibrary.wiley.com/doi/10.1002/sat.1175/pdf, January 2016. This approach maximizes the reuse of off-the-shelf 4G/LTE building blocks (Core Network) including packet processing and mobility management functions that takes care of Internet interfacing, QoS, user mobility and security. It also provide a convergent environment for the adaptation of 4G's RF transport (eNodeB) related designs for waveform coding, modulation, media resource allocation and security functions. Media access functions, which can leverage network-wide knowledge, can better leverage resource utilization and are of key importance for spectrum sharing.

On the user VSAT side, RF antenna, especially for directional tracking of orbiting nodes (such as LEO satellites), has traditionally faced complexity and cost challenges. The latest LEO constellations planned for the next 3 to 4 years can now provide economies of scale to enhance tracking antenna capability and reduce associated costs. Innovative tracking antenna technology will further accelerate convergence across multiple orbits since the same terminal will be able to access a variety of GSO and NGSO networking platforms. Besides satellites, they can also be served by High Altitude Pseudo Satellites (HAPS) which are likely to provide high density capacity in smaller coverage areas.

Dynamic spectrum sharing can significantly increase the reuse of unused spectral resources across diverse platforms. This can be better achieved with real-time analysis of spatial and temporal traffic demands in conjunction with geometrical considerations for Line-of-Sight (LOS) signal propagation based on radio path characteristics. Combined with historical resource usage information, regulatory constraints, and trajectory models of GSO and NGSO platforms, a convergent architecture can efficiently orchestrate the use of spectrum across multiple systems at finer time scales. Dynamic and granular spectrum management can precisely identify usable spectrum across multiple systems to address the ever increasing demands for higher data rates and lower propagation delays especially for mobile applications.

In the following disclosure, convergent design drivers across multiple dimensions, including spectral bands, orbits, service types, areas, traffic demand and their applicability at network, data link and physical layers, are first analyzed. This is followed by a discussion on architectural approaches, especially spectrum sharing at data link layer, which is enabled by leveraging a real-time multi-dimensional resource model and multi-tier resource availability orchestration. This model includes, besides the abovementioned facets, a characterization of platform trajectories, and directional RF antennas for LOS links amongst the network nodes, and gateways and user terminals. In conclusion some guidelines for future work are also provided.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

Example embodiments of the present invention are illustrated by way of example, and not by way of limitation, in the figures of the accompanying drawings, in which like reference numerals refer to similar elements, and in which:

FIG. 1 illustrates a canonical architecture of a wireless system utilizing RF links;

FIG. 2 illustrates standards-based building blocks for network layer packet processing for return links (communications links from the user terminal back to the gateway);

FIGS. 3A and 3B illustrate multi-dimensional resource availability space including directivity;

FIG. 4 illustrates a domain model for a convergence framework;

FIG. 5 illustrates a network level architectural convergence utilizing platform-specific RF links supported by a Platform Access Node (PAN);

FIG. 6 illustrates networked media access control with a centralized resource availability orchestrator;

FIG. 7 illustrates network-aware Media Access Control (MAC) with dynamically sized resource pools;

FIG. 8 illustrate timelines for three-tier resource orchestration.

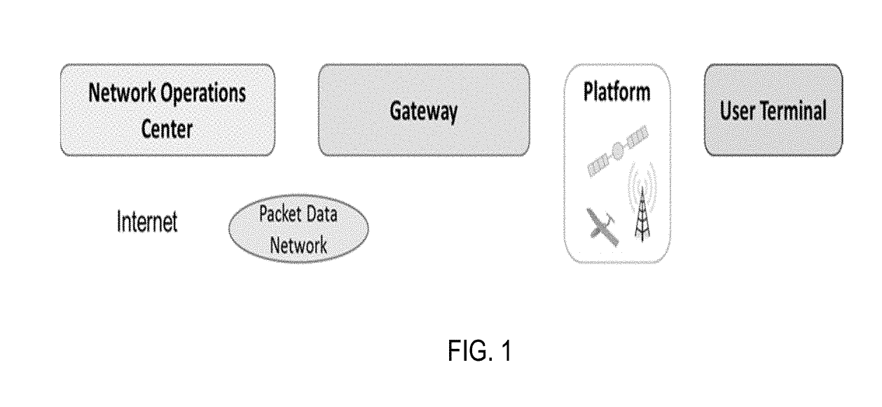

### DETAILED DESCRIPTION

An approach and network architecture for convergence across communications satellites (platforms) in various GSO and NGSO orbits, considering various facets including user network layer processing, spectral sharing, and costs within the context of broadband and IoT services, is described. In the following description, for the purposes of explanation, numerous specific details are set forth in order to provide a thorough understanding of the invention. It is apparent, however, that the invention may be practiced without these specific details or with an equivalent arrangement. In other instances, well-known structures and devices are shown in block diagram form in order to avoid unnecessarily obscuring the invention.

As will be appreciated, a processor, module or component (as referred to herein) may be composed of software component(s), which are stored in a memory or other computer-readable storage medium, and executed by one or more processors or CPUs of the respective devices. As will also be appreciated, however, a module may alternatively be composed of hardware component(s) or firmware component(s), or a combination of hardware, firmware and/or software components. Further, with respect to the various example embodiments described herein, while certain of the functions are described as being performed by certain components or modules (or combinations thereof), such descriptions are provided as examples and are thus not intended to be limiting. Accordingly, any such functions may be envisioned as being performed by other components or modules (or combinations thereof), without departing from the spirit and general scope of the present invention. Moreover, the methods, processes and approaches described herein may be processor-implemented using processing circuitry that may comprise one or more microprocessors, application specific integrated circuits (ASICs), field programmable gate arrays (FPGAs), or other devices operable to be configured or programmed to implement the systems and/or methods described herein. For implementation on such devices that are operable to execute software instructions, the flow diagrams and methods described herein may be implemented in processor instructions stored in a computer-readable medium, such as executable software stored in a computer memory store.

Further, terminology referring to computer-readable media or computer media or the like as used herein refers to any medium that participates in providing instructions to the processor of a computer or processor module or component for execution. Such a medium may take many forms, including but not limited to non-transitory non-volatile media and volatile media. Non-volatile media include, for example, optical disk media, magnetic disk media or electrical disk media (e.g., solid state disk or SDD). Volatile media include dynamic memory, such random access memory or RAM. Common forms of computer-readable media include, for example, floppy or flexible disk, hard disk, magnetic tape, any other magnetic medium, CD ROM, CDRW, DVD, any other optical medium, random access memory (RAM), programmable read only memory (PROM), erasable PROM, flash EPROM, any other memory chip or cartridge, or any other medium from which a computer can read data.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

### I. Convergent Design Drivers

The primary objective for enhancing convergence across heterogeneous satellite systems is to facilitate efficient sharing of satellite gateway infrastructure, networking equipment, and RF propagation environment in support of increased capacity, coverage, QoS and utilization. The following table (Table 1) provides a summary of the proposed architectural components and how they address key convergence drivers at network, link, and physical layers.

TABLE 1
Convergence drivers for various communications options.

| Layer | Drivers | Analysis | Architectural Component |
|---|---|---|---|
| Network | Packet | Standards-based | Off-the-shelf equipment |
| And | processing | common equipment | which provide full IP- |
| Above | and user | can cost-effectively | level packet processing, |
| | terminal | provide IP packet | security, and seamless |
| | mobility | classification, | support for user |
| | | policing, queuing, | terminal mobility. |
| | | scheduling, security | |
| | | while supporting | |
| | | user terminal | |
| | | mobility. | |
| Data | Resource | Maximize RF | Networked Medial Access |
| Link | Utilization | spectrum utilization | Control (MAC) based on |
| Media | | across cooperative | a centralized data broker |
| Access | | systems by | scheme for resource |
| | | leveraging | sharing. |
| | | orthogonality in | |
| | | time, frequency, | |
| | | and direction of | |
| | | signal transmission. | |
| Physical | Spectral | Maximize signal | Networked transmission |
| Trans- | Efficiency | power and minimize | burst scheduler with |
| mission | | co-channel and | dynamic power control. |
| | | adjacent channel | See Ravishankar, |
| | | interference for | BenAmmar, Huang, Gopal, |
| | | maximum spectral | and Corrigan, “High |
| | | efficiency (with | Data Rate and Bandwidth |
| | | adaptive coding | Efficient Designs for |
| | | and modulation | Satellite Communication |
| | | schemes). | Systems,” ICSSC 2017. |

A standalone communications system typically comprises multiple instances of gateway between the Internet (IP based packet data network) and the platform that is serving large number of user terminals. Traditionally, such a gateway is standalone and does not share data link or physical layer information with other gateways and/or other systems and uses dedicated RF spectrum for establishing wireless links to the UTs via the platform. Such a stove-piped architecture is acceptable when spectrum is abundant or the system utilization is very high across all service areas and at all times within a system. However, with increasing demands and spectrum scarcity better utilization is warranted across many systems.

Table 2 summarizes the salient features of diverse network platforms in various orbits, and primary convergence opportunities and unique applications each of them can support. Out of the many multiple-access schemes possible, for example, a Time Division Multiple Access (TDMA) based transmission can easily use a frame size of 10% of associated propagation delay (subject to practical processing capabilities).

TABLE 2
Convergence opportunities across diverse transport platforms.

| | Altitude | | LOS | | | | | | |
|---|---|---|---|---|---|---|---|---|---|
| | Min | | Max | | | Convergence | Distinctive | TDMA | |
| Platform | Delay | | Delay | | Salient Features | Opportunity | Application | Frame | |
| GEO | 35,786 | km | 41,672 | km | Fixed antenna | Mature IP | Streaming | ~30 | ms |
| Satellite | 239 | ms | 278 | ms | for stationary | network | Video | | |
| | | | | | UT. Very large | infrastructure. | | | |
| | | | | | coverage areas. | | | | |
| MEO | ~8,000 | km | 12,881 | km | Selected spot | May follow | Web | ~9 | ms |
| Satellite | 53 | ms | 86 | ms | coverage areas | GEO/LEO lead | Applications | | |
| | | | | | including | for convergence. | | | |
| | | | | | oceans. | | | | |
| LEO | ~1,200 | km | 4,090 | km | Global coverage, | New | Interactive | ~3 | ms |
| Satellite | 8 | ms | 27 | ms | including polar | constellations | Games | | |
| | | | | | regions, and low | can easily | Tele-surgery | | |
| | | | | | delay. | benefit from | | | |
| | | | | | | standards-based | | | |
| | | | | | | architecture [1], | | | |
| HAPS | ~24 | km | 554 | km | Fixed antenna | May follow | Autonomous | ~0.3 | ms |
| | 0.16 | ms | 3.7 | ms | and low delay. | GEO/LEO lead | Vehicle | | |
| | | | | | Small coverage | for convergence | Control | | |
| | | | | | area. | | Channel | | |
| Cell | ~0.05 | km | 25 | km | Deployment cost | Definitive and | All | ~0.1 | ms |
| Tower | 0.00033 | ms | 0.16 | ms | justified for | largest IP-based | applications | | |
| | | | | | populated areas | industry | subject to | | |
| | | | | | (backhaul links). | standard (4 G | coverage | | |
| | | | | | | and 5 G) | | | |

### A. Reuse of 4G/LTE Core Network Architecture

Of all existing communications system options, cellular technology is most mature and most widely deployed. Management, control, and data plane protocols have been standardized for various types (e.g., 4G specifies 9 traffic classes) broadband multimedia data and a large variety of applications within the 4G framework allowing significant competition amongst vendors and availability of cost-effective networking equipment. As we show later, 4G/LTE standards offer a key part of our convergence approach and most of the 4G core network components for packet processing and user mobility management can be reused. However, each transport platform would still require its own platform-specific adaptation of the RF link management including the MAC function which is key to spectrum sharing. In the management plane all authentication, service policies, bearer definition, and charging functions of the 4G family can be reused to provide a common management substrate across diverse transports.

### B. Network Layer

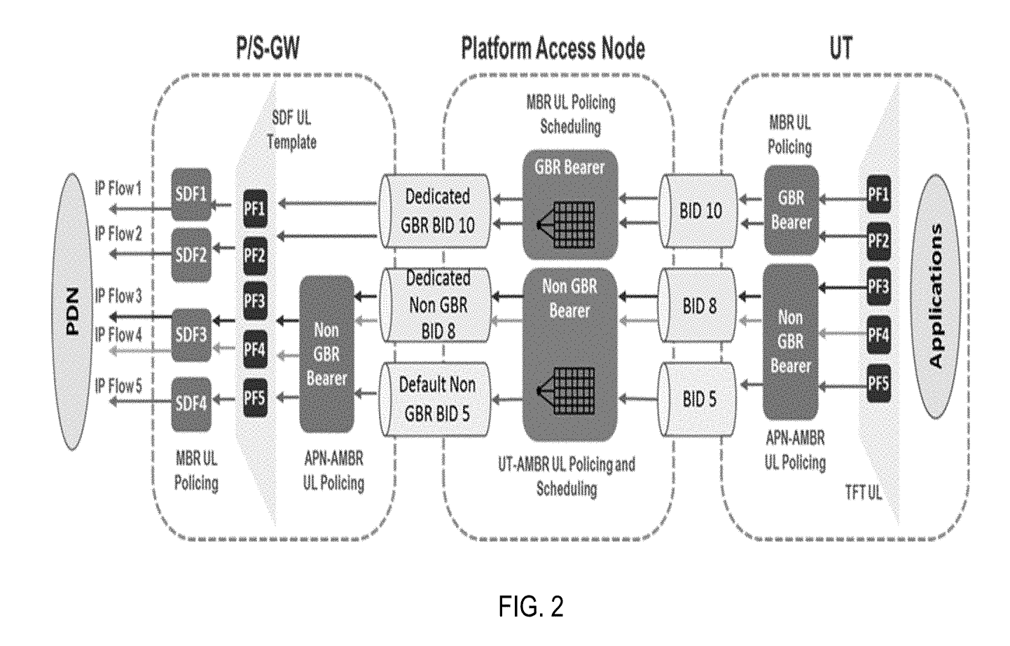

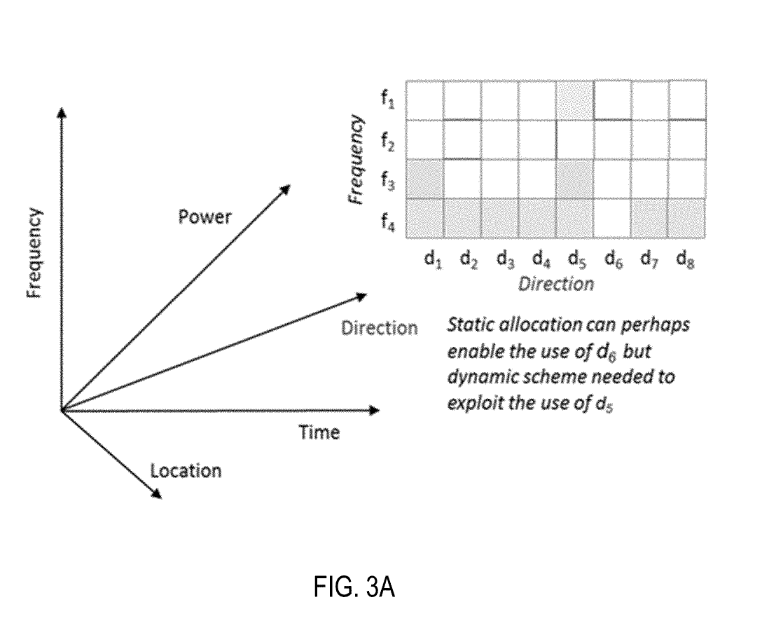

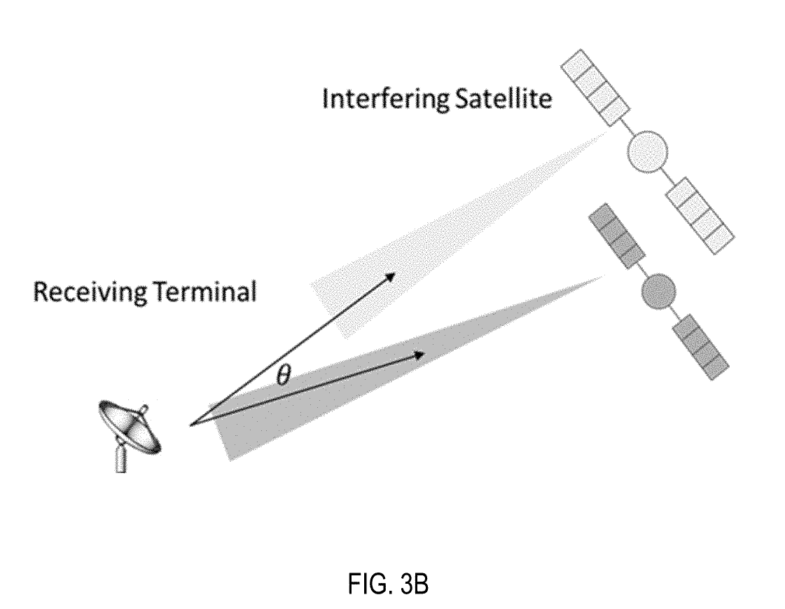

Network layer processing has matured over the past few years, and cellular data transport architecture has evolved into 4G/LTE as the most prescriptive and deterministic framework for user data classification, prioritization, and scheduling for both forward (from gateway) and return (from UT) links. The 4G/LTE standards allow a UT to interface with multiple Packet Data Networks (PDN) with policy based application data (service data flow) transport over one or more bearers, optionally with Guaranteed Bit Rate (GBR). While Platform Access Node (PAN) is platform specific and is derived from the standards-based eNodeB component of 4G/LTE, rest of the 4G/LTE building blocks including PDN Gateway (PGW) and Serving Gateway (SGW) are shared across platforms. A typical functional allocation for return link across ground infrastructure and UT at packet processing level is shown in FIG. 2.

### C. Data Link Layer

MAC, part of the data link layer, in a shared environment requires dynamic knowledge in frequency, time, and direction of transmission so that an individual radio link (either uplink or downlink) does not interfered by other communication links when a system operating along with other cooperative systems. Interference I for such a link depends on the transmit power P_{T} of an interferer and alignment between the subject (where G_{R}(θ_{R}) is the receiving antenna gain and G_{T}(θ_{T}) is the transmitting antenna gain) and free space loss is FS_{L}. Here θ_{T} and θ_{R} are the angles between the interfering antenna and receiving antenna boresights, and the direction of the interfering link, respectively.

I=P_{T}+G_{R}(θ_{R})+G_{T}(θ_{T})−FS_{L} (in dB)

Antenna gain in a specific direction is a function of maximum gain (along boresight) and the angle between the boresight and the specific direction. Interference in the GEO orbit, for example, is mitigated by keeping θ>2° for any two satellites sharing the same frequency (which requires the use of directional antenna on both satellites and earth terminals). From a specific location on the surface of the earth, a user terminal antenna needs to have a minimum elevation angle (typically at least 10° to avoid blockage because of nearby foliage or other structures. Even though GEO satellites are placed over the equator, satellites in NGSO orbits and HAPS have no such restrictions which creates significantly more options for multiple platforms potentially sharing the same frequency. By leveraging both elevation (with total 80° to spare), azimuth (with total 360°) and assuming a 2° separation, it is theoretically possible to reuse the same frequency across multiple platforms by a factor of 180×40=7200 with respect to a specific location. Note that some, but not all, of these directions may already have been leveraged in multiple static allocation of the same frequency across systems using links that will not interfere with each other.

In practice, frequency reuse enabled by exploiting directivity or LOS antennas will be constrained by implementation losses, inaccurate estimates for traffic and RF environment, and sharing of a platform by multiple user terminals. The profile of a common beam that is serving a large number of terminal will require that the platform antenna aim in a direction to best serve the aggregate of all user terminals instead of optimizing one terminal at a time. This would also require keeping track of all regulatory constraints while rapidly determining if a specific frequency in a direction for some time duration is not going to be used. In addition, since the non GSO platforms are mobile with respect to a location, their orbital location and directivity with respect to the location will have to be constantly and accurately tracked while making media access decisions across multiple systems with sub-second timelines.

### D. Physical Layer

The capacity of a specific radio link depends on the ratio of signal power to the combination of both background noise and interference from other systems. With networked MAC, there are additional opportunities for dynamically using maximum power, through coordination, without creating unsurmountable interference to the neighboring beams of the same and other cooperative systems. An intra-system scheme for enhancing data rates with networked scheduling within a system. See Ravishankar, BenAmmar, Huang, Gopal, and Corrigan, “High Data Rate and Bandwidth Efficient Designs for Satellite Communication Systems,” ICSSC 2017.

### E. Multi-Dimensional Resource Availability Space

Traditionally, schemes such as Multi-Frequency Time Division Multiple Access (MF-TDMA) have exploited the dynamic use of frequency and time slots for sharing spectrum within a system. This can easily be extended with better coordination across multiple systems. By keeping track of the direction of signal transmission across platforms, many orders of more resources can become available across systems. Other waveforms, such as Code Division Multiple Access (CDMA) can additionally benefit from careful “sharing” of signal power environment across diverse systems.

### II. Architechural Framework for Convergence

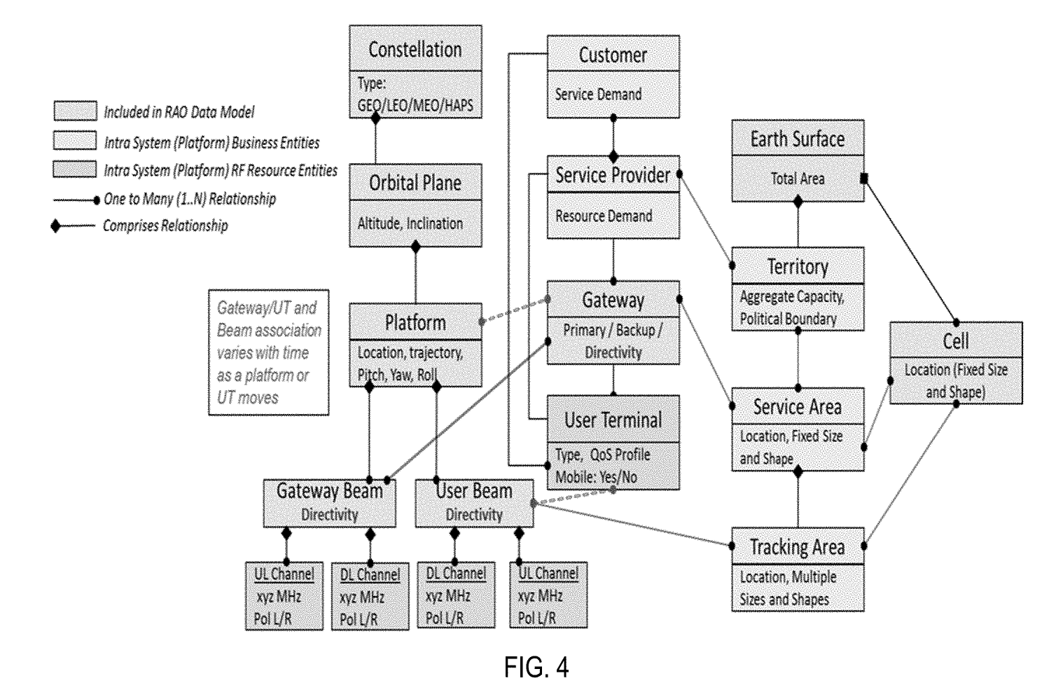

Convergence across platforms in multiple orbits can be facilitated by taking an architectural approach that reuses the existing building blocks, maximizes off-the-shelf equipment, and leverages new components that can easily be interfaced with the existing common network infrastructure via standard interfaces. FIG. 4 provides a high-level domain model for the convergence framework and the following subsections analyze this framework at network and data link layers followed by a summarized implementation approach. Convergence across multiple layers involve precise coordination of associated functions supporting their respective platform-based networks.

### A. Network Layer Convergence

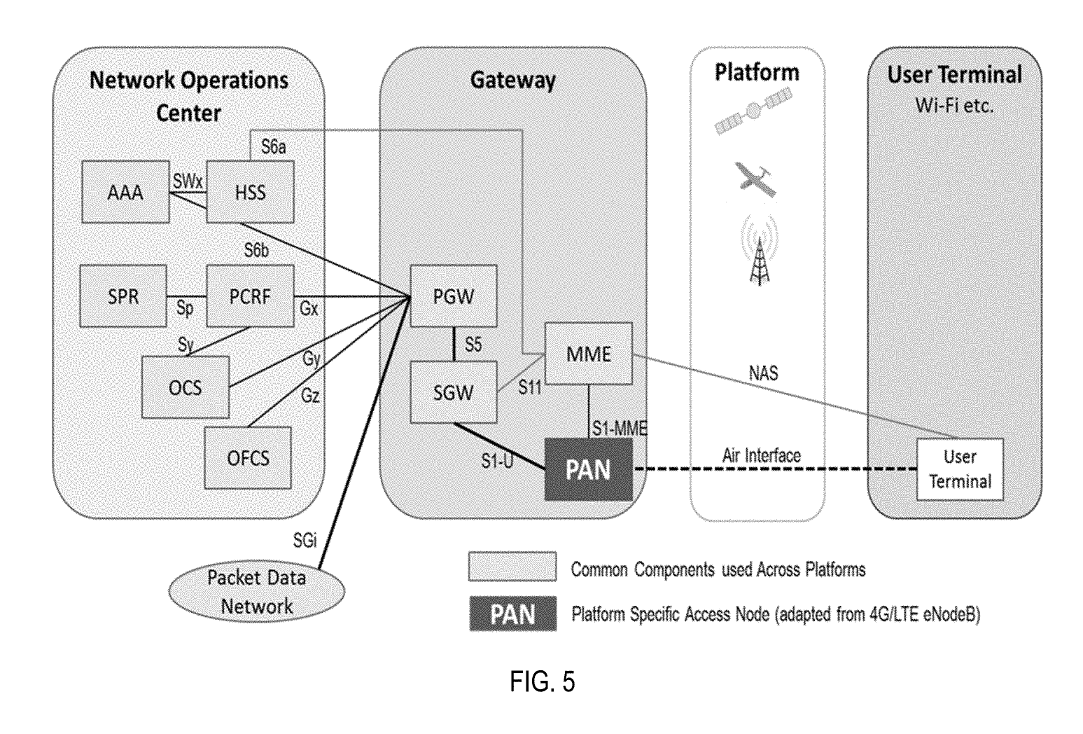

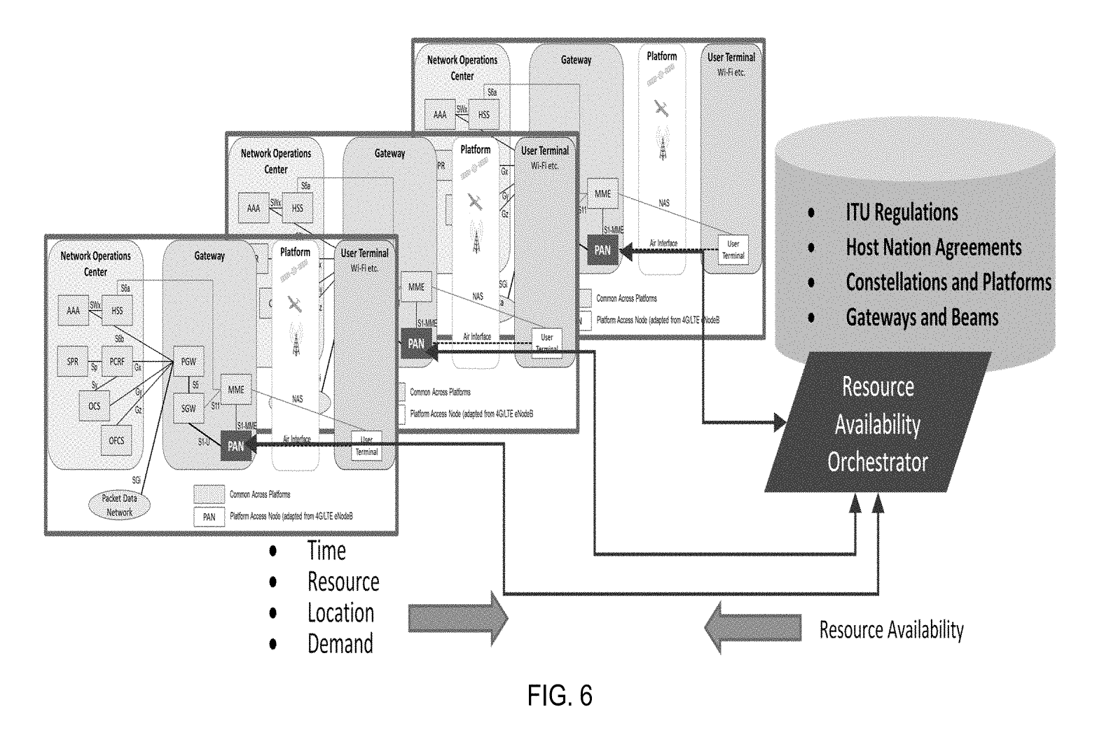

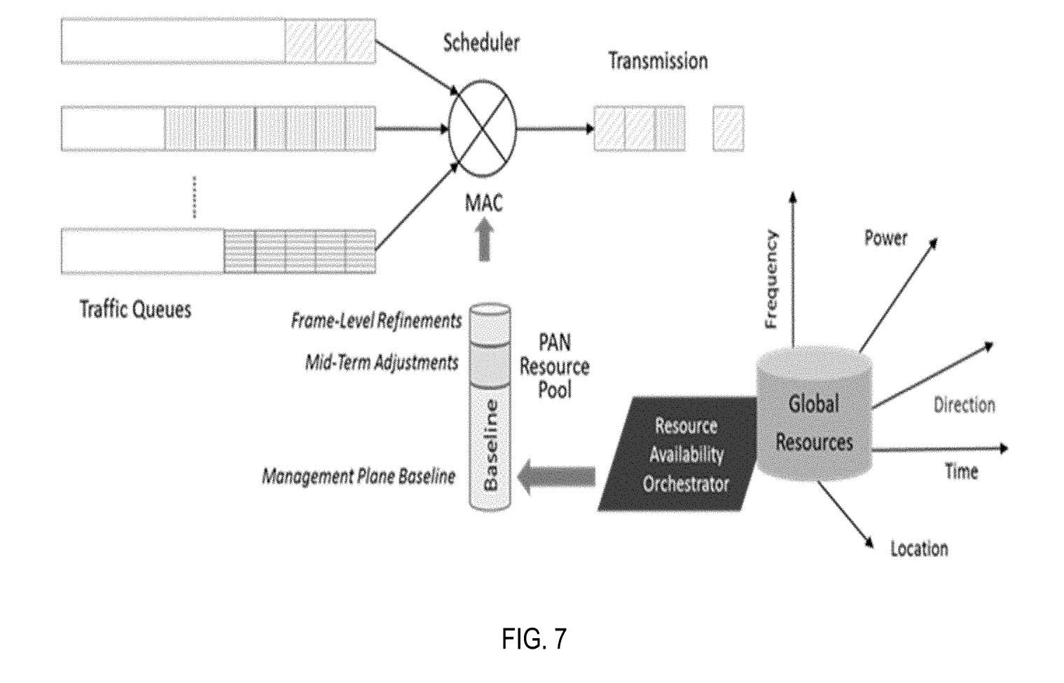

The 4G/LTE Core Network (Evolved Packet Core) provides the bulk of network layer convergence for our architectural framework, as summarized in FIG. 5. Core Network provides packet level interface to external entities (Internet, Data Centers, and Enterprise Networks) and includes associated data and control plane functions to provide packet-flow level channels to Platform Access Node (PAN). In 4G/LTE, QoS aware channels are automatically setup based on UT's service profile maintained by the following components. P/S-GW provides data plane functions and per-user based packet processing (addressing, bearer setup) towards the internal interface to PAN. They terminate packet interfaces to external terrestrial interfaces and performs deep packet inspection to support various QoS objectives and performs related packet processing functions. P/S-GW act as local mobility anchor point for inter PAN handovers for the vehicular user and buffers data intended to an idle user terminal. Mobility Management Entity (MME) provides control plane (security, registration, mobility, QoS,) interface to PAN through the IP-based S1-control interface.

Core Network also includes functions that may physically be located in centralized NOC sites. These functions manage subscriber and service level information for UTs. Policy and charging functions provides policy control decision and flow based charging control functions and enable the user plane detection of, the policy control and proper charging for a service data flow and authorizes QoS resources for the user terminal bearer (managed by P/S-GW). Home subscriber management includes subscriber identities, service profiles, authentication, authorization and quality of service (QoS) for UTs and is the master repository for subscriber/device profiles, and state information. Specific functions provided by some of the main 4G components, which are used without any changes in the convergence framework, are enumerated below:
PGW PDN-Gateway: PDN interface termination point, per user packet filtering, lawful interception, UT IP address allocation, mobility anchor point, transport level packet QoS marking, and UL and DL service level charging, UL and DL rate enforcements.
SGW Serving Gateway: user plane connectivity of UT to PDN, end-marker for inter-gateway handover, lawful interception point, data buffering for idle UT, and transport level packet QoS marking.
MME Mobility Management Entity: standard interface to 4G eNodeB adaptation as PAN, signaling termination from UT, signaling security, UT power saving mode management, connection management for UT-P/S-GW association, UT handover due to mobility, UT authentication and authorization in coordination with HSS, packet bearer management, lawful interception of signaling, and PGW selection based on HSS profile of UT.
HSS Home Subscriber Server: master database for UT and service profiles, and security information for UT, support for routing and roaming procedures.
PCRF Policy and Charging Rules Function: policy control decision, flow based charging control, control for service data flow detection, QoS and flow based charging, and resource authorization for UT bearers.

The eNodeB component of the 4G architecture needs to be adapted based on platform specific characteristics including the following functions: media access control, modulation and de-modulation, channel coding and de-coding, radio resource control for transmission, measurement processing and handover decision for mobility (both platform and UT), platform mobility, and data link protocols for physical layer error correction.

### B. Data Link Level Convergence

The PAN component for a platform handles all modem, related media access, and scheduling functions. A centralized Resource Availability Orchestrator (RAO) is utilized by each platform-specific PAN to dynamically learn about resources as they become available in time, frequency, and direction dimensions. Logical centralization of RAO allows a streamlined way to maintain awareness of location and (as needed) mobility of all platforms, their beam/coverage specifics, and respective unused frequency resources with time durations. A multi-dimensional data structure keyed by location, time, platform, and frequency, publishes resource availability information by potential use by each platform specific MAC. At the data link layer, scheduling function within a PAN uses RAO and schedules transmissions in time and frequency domains (including a mix of MF-TDMA, FDMA, CDMA and OFDM schemes).

### C. Physical Layer Convergence

At the physical layer, the scheduler within a PAN selects specific power levels consistent with the constraints from the RAF. High signal transmission power level allows the use of spectrally efficient modulation schemes resulting in higher data rates as introduced in Ravishankar, BenAmmar, Huang, Gopal, and Corrigan, “High Data Rate and Bandwidth Efficient Designs for Satellite Communication Systems,” ICSSC 2017. RAO allows networking of physical layer coordination across diverse transports and respective platforms.

### D. Implementation Approach

Resource orchestration involves multi-plane integration of a centralized RAO and the MAC component of the PAN associated with each platform. RAO maintains a scalable database that efficiently stores indexed data related to regulatory constraints, PAN locations, platform locations and trajectories, and the relationship between platforms and PANs. In addition, it manages business information pertaining to the use of platforms and PANs for services and arrangements for using and exchanging resources. Either two-party or centralized brokerage of bartering or sale of resources is compatible with our approach. Resource prices can vary based on specific decision making timeline, demand, and supply.

Each PAN periodically (long-term loop) provides an assessment, based on expected traffic, of estimated resource usage, indexed by location and time. This information is used to provide a big-picture view of aggregated demand and supply across diverse systems sharing common RF spectrum. This also establishes a resource pool baseline for each system and allows the RAO to carve out a part of the total resources that are clearly available for dynamic allocation across all systems. In the mid-term loop, each PAN provides an estimate of any additional resource that is needed or will go unused in the next few seconds to minutes based on recent traffic trends seen by the respective system.

RAO uses a publish-and-subscribe model to announce the availability of additional resources which can subsequently be confirmed for acquisition by a PAN in need of more resources. This information is used to adjust the resource pool used by the MAC controller within a PAN for allotting near future time and frequency slots in a specific direction. Finally, in the frame level short-term loop each MAC controller, based on actual traffic (by measuring respective packet queues within a PAN), provides the most accurate measurement-based estimate of resource demand that helps in returning any unused resources for rapid sharing of resources by other PANs.

TABLE 3
Algorithmic approach for implementing
Resource Availability Orchestrator.

| Time | Plane | | | |
|---|---|---|---|---|
| Cycle | Timeline | Function | Input Data | Output |
| Long | Management | Identify | Baseline | Model |
| Term | Minutes- | resources that | resources | comprising |
| Loop | Hours | are likely to go | needed by | resources |
| | | unused based | each PAN | available for |
| | | on historical | based on | sharing across |
| | | data and | service | diverse |
| | | provisioning | definitions, | systems. |
| | | | business | Exchange |
| | | | models, and | may be |
| | | | long term data | accomplished |
| | | | analytics | directly by the |
| | | | | two involved |
| | | | | parties |
| Mid | Control | Orchestrate | Estimate of | Incrementally |
| Term | Seconds- | fine tuning of | additional | adjusted pools |
| Loop | Minutes | resource pools | resources | of resources |
| | | estimated in | required or | available for |
| | | long-term loop | available | sharing across |
| | | | based on | systems |
| | | | PAN-specific | |
| | | | short term | |
| | | | trends | |
| Short | Data | Identify | Measurement | Finalized and |
| Term | Milliseconds- | resource | of actual | most accurate |
| Loop | Seconds | availability | traffic | resource pools |
| | | based on actual | likely to be | available for |
| | | traffic queued | transmitted | sharing across |
| | | in each PAN | in next few | systems |
| | | | frames in a | |
| | | | PAN | |

The fastest short-term loop for resource orchestration uses most definitive information about traffic demand, and RF propagation environment. This timeline has to support several different types of waveforms across various systems and their respective MAC implementations. The orchestration short-term timeline aligns with the individual frames of the various system by using the lowest common multiple of individual frame sizes. Typically, GEO systems are likely to have the longest frames while HAPS and cellular systems would have the shortest.

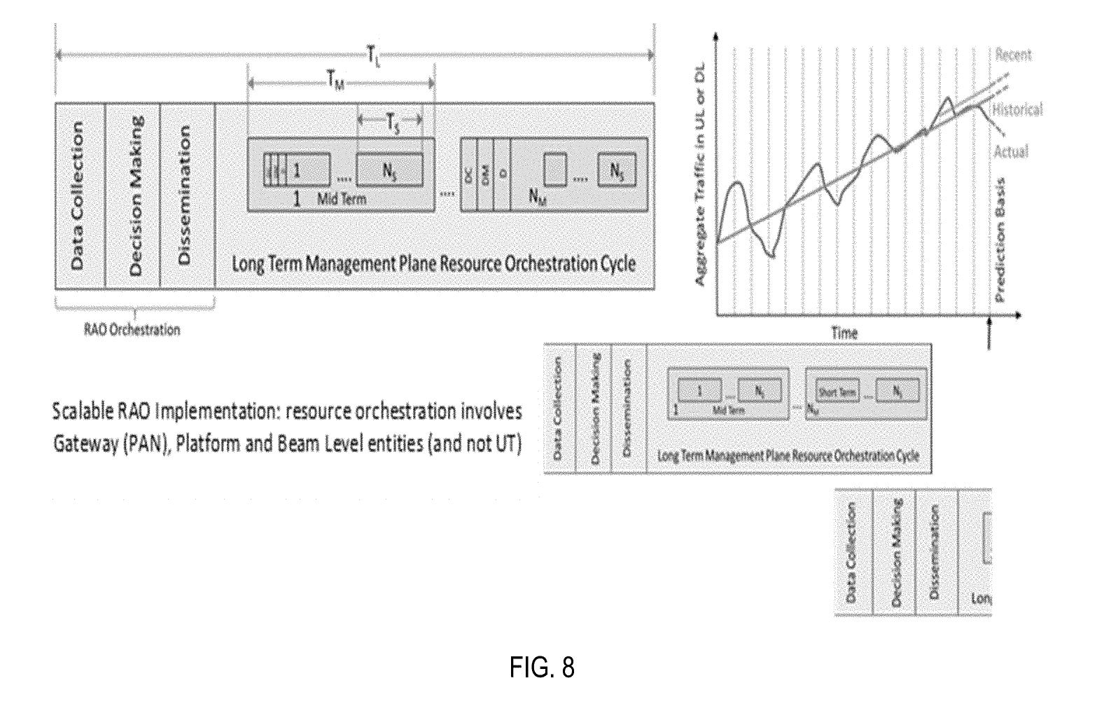

Multi-tier resource allocations allows sufficient time for compute-intensive long term planning which defines a parameterized model for subsequent mid-term and short-term cycles for refinement of the parameter values. All parameters, including the timelines and number of mid-term and short-term cycles are determined dynamically based on optimization goals and computing resources available for finding the best operating points. Directivity is handled, for example, by using two-line element (TLE) type approach for time-based prediction of position and velocity of the moving end-point (platform) with respect to a ground reference. The timelines, as shown in FIG. 8, are related as follows: T_{L}=N_{M}·N_{S}·T_{S} where T_{S}, for example, could be the lowest common multiple of all TDMA frame sizes. With GEO satellites in the mix, this value is likely to be 10 s to 100 s of ms, which is sufficient for computing and exchanging spectrum sharing information over dozens to hundreds of sites (PANs and ROA) for a specific region connected over fast fiber links.

### III. CONCLUSION

We have defined a convergent architecture enabling the coexistence of diverse platforms in various orbits and enabling utilization of spectrum which would otherwise go unused. We have developed a framework for increasing efficiency with the use of common networking equipment based on 4G/LTE standards as they evolve into the next 5G generation. In future, all wireless systems are expected to start leveraging higher RF bands traditionally used today by satellites and terrestrial high data rate links which opens up the possibility of significant spectrum sharing. We have introduced a novel concept of MAC level resource sharing with the use of a networked Resource Availability Orchestrator (RAO) that can dynamically publish resources in frequency, time, location, power, and most importantly directivity dimensions which would otherwise go unused but can dynamically be allocated to other cooperating systems. Unlike a cognitive radio based scheme where dynamic RF sensing is used to identify gaps for potential utilization, our scheme is based on deterministic knowledge shared by cooperative systems. Only software-based MAC functions requires to be interfaced with a centralized ROA without making any change in physical layer of the participating systems. Multi-tier ROA design allows the development of a parameterized dynamic resource model that allows fast and incremental refinement of parameters as more accurate information becomes available.

We are currently exploring the development of quantitative model to fine-tune these timelines and estimate the aggregate capacity increase possible with additional utilization of these unused resources. The timelines include data propagation across Platform Access Node of each system and ROA, and computational time within the ROA based on dynamically collected data from PANs and the use of other datasets maintained by ROA. These datasets include regulatory constraints, platform orbits and trajectories, and RF propagation models and would involve the use of novel data structures. Another area of future work would be to globally prioritize resources for stratified pricing and globally optimal allocation by an enhanced ROA.

While example embodiments of the present invention may provide for various implementations (e.g., including hardware, firmware and/or software components), and, unless stated otherwise, all functions are performed by a CPU or a processor executing computer executable program code stored in a non-transitory memory or computer-readable storage medium, the various components can be implemented in different configurations of hardware, firmware, software, and/or a combination thereof. Except as otherwise disclosed herein, the various components shown in outline or in block form in the figures are individually well known and their internal construction and operation are not critical either to the making or using of this invention or to a description of the best mode thereof.

In the preceding specification, various embodiments have been described with reference to the accompanying drawings. It will, however, be evident that various modifications may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system for convergence across a plurality of communications platforms in various geosynchronous and non-geosynchronous orbits, comprising:
a core network (CN) and a Platform Access Node (PAN), wherein the CN configured to provide a packet level interface to external entities, and associated data and control plane functions to provide packet-flow level channels to the PAN;
a packet gateway (PGW) and serving gateway (SGW), or P/S GW, configured to provide data plane functions and per-user based packet processing for an internal interface to the PAN, to terminate packet interfaces to external terrestrial interfaces and perform deep packet inspection to support quality of service (QoS) objectives and perform related packet processing functions, and to provide a local mobility anchor point for inter-PAN handovers for mobile user terminals and to buffer data intended for idle user terminals; and
a mobility management processor (MME) configured to provide a control plane interface to the PAN through an IP-based S1-control interface; and
wherein the PAN is further configured to (i) handle modem, related media access and scheduling functions, employing a centralized Resource Availability Orchestrator (RAO), wherein the RAO is configured to dynamically determine resource availability in real-time, frequency and direction dimensions, which facilitates a dynamic awareness of location and mobility of each of the plurality of communications platforms, their respective beam/coverage specifics and respective unused frequency resources with time durations, and to publish a multi-dimensional data structure reflecting resource availability information for potential use by platform specific MAC, wherein the multi-dimensional data structure is keyed by location, time, platform and frequency, and
wherein, at the data link layer, a scheduling function within the PAN is configured to schedule transmissions in time and frequency domains based on the multi-dimensional data structure published by the RAO.
